(19) United States
(12) Patent Application Publication
(10) Pub. No.: US 2011/0178991 A1
(43) Pub. Date: Jul. 21, 2011

(54) METHOD FOR OPERATING AN ARCHIVING SYSTEM FOR DATA SETS, IN PARTICULAR MEDICAL IMAGE DATA SETS, AND ARCHIVING SYSTEM

(75) Inventor: Björn Nolte, Furth (DE)

(73) Assignee: SIEMENS AKTIENGESELLSCHAFT, Munich (DE)

(21) Appl. No.: 12/913,811

(22) Filed: Oct. 28, 2010

(30) Foreign Application Priority Data
Jan. 20, 2010 (DE) 10 2010 005 172.1

(51) Int. Cl. G06F 17/30

(52) U.S. Cl. 707/668; 707/E17.005

(57) ABSTRACT

A method is disclosed for operating an archiving system for data sets, in particular medical image data sets, by way of a storage device having at least one storage medium including physical memory areas. In at least one embodiment, such data sets are stored in such a way that they fill up the memory areas in chronological sequence.

### PRIORITY STATEMENT

The present application hereby claims priority under 35 U.S.C. §119 on German patent application number DE 10 2010 005 172.1 filed Jan. 20, 2010, the entire contents of which are hereby incorporated herein by reference.

### FIELD

At least one embodiment of the invention generally relates to a method for operating an archiving system for data sets, in particular medical image data sets, by way of a storage device having at least one storage medium comprising physical memory areas, and an associated archiving system.

### BACKGROUND

In the area of medical technology it is normal—using various procedures—to archive recorded data sets in an archiving system, firstly to enable them to be located later, but also to enable the image to be referred to later. Such archives of medical image data sets are growing at an ever-increasing rate, since new methods and imaging equipment are resulting in improved image quality and therefore also in larger image data sets.

In such enormous archives, problems often occur when a backup is to be carried out or when the image data sets need to be transferred—i.e. copied—in their entirety, for example because of a system change. While such transfers or backups are taking place, the archiving system must be switched offline because of the complex access to the storage device. This means that the image data sets cannot be accessed during that time. Moreover, such backups or transfers are enormously time-consuming.

A frequently used format for medical image data sets is the so-called DICOM format, in which the pure image data is stored in the image data set together with metadata containing further information about the image data. Various storage services and protocols are known for the DICOM format; however they all have the performance problems mentioned above.

### SUMMARY

In at least one embodiment of the invention, a method is provided for operating an archiving system in which offline time due to transfers or backups is largely avoided and less time-consuming backup and/or transfer processes are made possible.

In at least one embodiment, a method provides for the data sets to be stored in such a way that they fill up the memory areas in chronological sequence.

The archiving system therefore has a storage device comprising at least one storage medium, which has physical memory areas. The storage medium will normally be a hard disk which has sectors as memory areas. RAIDs (redundant array of independent disks) are used in preference. At least one embodiment of the invention could also be used for SSD (Solid State Disk) memory systems, in which separate read and write processes are advantageous. At least one embodiment of the invention therefore proposes that the memory layout of the data sets—compared to the known method of uncorrelated storage—should be implemented in a targeted way such that data sets are physically separated in the storage medium, in particular the hard disk, according to their age. Unlike conventional file systems, which do not fill up storage media physical memory area by physical memory area, at least one embodiment of the inventive method proposes just such a procedure. A physical memory area therefore always ultimately exists, in which new incoming data sets are stored (write area), whilst physical memory areas that are already filled ultimately remain unchanged—these may therefore be regarded as pure read areas (apart from any minor changes to be carried out, further details of which are described below). Such areas may be regarded as read areas.

However, this means that almost all memory areas—almost all sectors of a fixed data system, for example—are not written or updated during daily routine tasks. This in turn means that the archiving system does not have to be taken offline during transfer or backup of these areas, since no write operations take place there in any case. In addition, a copying process can be carried out more quickly because the data has been physically pre-sorted.

Particular advantages may be achieved with at least one embodiment of the inventive method in an archiving system for medical image data sets, such as—for example—may be applied in a clinic where the image data sets ideally need to be available around the clock for retrieval or other tasks.

In at least one embodiment of the inventive method, therefore, the actual way in which data is stored is influenced on a physical level by targeted control of the storage device or of its storage media. At least one embodiment of the inventive method is therefore an active control process for the storage device of an archiving system which influences its specific technical functionality—in this case, the data storage location. At least one embodiment of the invention proposes two alternative ways of achieving this.

Firstly, provision may be made whereby the physical storage location is selected directly by a control unit of the storage device. In this case, therefore, a direct, controlling access to the storage device ensures that the different memory areas are accordingly filled up in succession by the data sets. For hard disks, for example, a disk controller provided in the form of hardware or software is used as the control unit, the functioning of which may be modified accordingly to enable at least one embodiment of the inventive method to be carried out.

In an alternative embodiment, however, it is preferable for addresses in a file system to be allocated to the memory areas via a function of a file system, with data being stored according to the addresses selected. This variant therefore exploits a functionality of the file system which exists anyway and which enables physical memory areas to be addressed directly in the file system via definable addresses, in order to carry out the inventive method. A prominent example of such a function is the facility for partitioning storage media, in particular hard disks. Such a partition, often also called a logical drive, is assigned a corresponding address in the file system. According to the invention, a great many such partitions are generated—possibly even one for each physical memory area, for example each hard disk sector—which are filled up with data sets in chronological sequence.

Provision may be made, particularly advantageously, whereby an index database used for administration of the data sets is stored in a specially reserved index memory area. For example, if medical image data sets, which have a very high volume, are viewed in DICOM format, a database is most often used as an index to enable data sets to be quickly located on the basis of search criteria. Such an index database used for managing data sets is regularly updated during routine operation of the system, so that—in this case—a special index memory area is advantageously assigned which consequently forms a write area, to use the aforementioned nomenclature. This means that, in addition to the memory area currently being filled up, there is a further write area for the database.

In a particularly practical embodiment of at least one embodiment of the inventive method, provision may be made so that the data sets include at least one item of metadata, wherein updating data for at least one item of metadata is stored in the index memory area. This means that, when metadata of data sets is updated, the data set is not immediately updated. Instead, this data is held initially in the index memory area for updating later. The updating of a data set on the basis of the update data may preferably be carried out only when the data is exported from the archiving system. This ensures that a data set that was once stored in the storage device is not changed thereafter—consequently actual physical memory areas are formed to which access must be read-only. Memory accesses are no longer necessary, so that it is possible to ensure with even greater certainty that offline periods in the archiving system are avoided.

One example of such updating data in the archiving of medical image data sets is the so-called Patient Information Reconciliation (PIR) data. This enables changes in patients' addresses or similar to be noted. With at least one embodiment of the inventive method, it is now possible for the image data sets in the archive to be updated only when the image data sets are sent over the network from the archiving system or exported to external storage media. Such a process is also known as “lazy write”.

Further provision may expediently be made in general whereby, when data sets are backed up and/or transferred, they are copied memory area by memory area by way of a copying program that directly addresses the memory areas. Such software, which directly reads memory areas, is already known—for example as “sector copy” in the case of hard disks. This enables the backup and/or transfer program to be accelerated considerably and maximum performance to be achieved during transfer or backup. Where appropriate, the use of such copying programs may be limited to the read areas, i.e. the memory areas in which writing or updating are no longer necessary thanks to at least one embodiment of the inventive method.

In such backup and/or transfer processes, provision may be made whereby the operation of other administration functions of the archiving system is deactivated only while the memory area that is currently being filled, and possibly the index area, is being accessed. However, it should be noted that this would involve only a very short period of downtime, in comparison to deactivating the archiving system during the entire backup or transfer process.

In the case of such backup or transfer processes it is always expedient to optimize the parameters of the corresponding protocols. Provision may therefore be made, for example, for protocol parameters to be dynamically optimized to the capacity of the memory areas in order to achieve maximum transfer rates and to minimize the use of resources (CPU, storage device input/output). Nevertheless, the existence of a backup and/or transfer process does represent a certain level of system utilization, in which case provision may expediently be made whereby the priority of a backup- and/or transfer process may be adjusted by the user. A user may therefore influence, in particular by using a simplified control element, the allocation of resources to the backup and/or transfer process, for example if the computer power is required for a complex evaluation or similar.

Furthermore, provision may be made to particular advantage whereby, when data sets are backed up and/or transferred, at least one or, where appropriate, one additional checksum, is calculated for the data sets, in particular a checksum for each data set and/or for groups of data sets, on the basis of which it is determined, by comparison of the checksum after the copying process, whether the copying process has been successfully concluded. Some current copying programs do already have functions for checking the copying process, but it has proven beneficial—particularly in the case of critical data such as medical image data sets—to provide a further safeguard in the form of a checksum check. Whilst a checksum may, of course, be calculated and compared for all of the data in the archive after the transfer is completed, it is also possible for such a process to be provided for each data set or for groups of data sets, and also—in particular—for the data sets stored in a physical memory area. Known checksum algorithms, for example, may be used for this purpose, such as an md5sum algorithm.

In addition to the method, at least one embodiment of the invention also relates to an archiving system for data sets, in particular medical image data sets, having a storage device with at least one storage medium comprising physical memory areas and incorporating a storage device designed for executing at least one embodiment of the inventive method. All embodiments relating to at least one embodiment of the inventive method may be applied analogously to the inventive archiving system. In particular, such an archiving system also enables lengthy offline periods caused by transfers or backups to be avoided and the transfer or backup process to be accelerated.

Provision may be made, in particular, whereby the control device is a central server connected to the control device, via which at least one work station accesses the data sets. The server may also be designed, for example in the case of a system for archiving medical image data sets, to carry out calculations relating to the image data sets, for example evaluations, for which purpose the server advantageously has several processors. The storage device may be integrated into the server, but it is also possible for the server to access the external storage device. The data sets may be accessed via workstations which are connected to the server via a network, for example an intranet.

### BRIEF DESCRIPTION OF THE DRAWINGS

Further advantages and details of the invention will emerge from the example embodiments described below and from the diagrams. In these:

FIG. 1 shows an archiving system according to an embodiment of the invention, and

FIG. 2 shows the filling of memory areas according to an embodiment of the inventive method.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

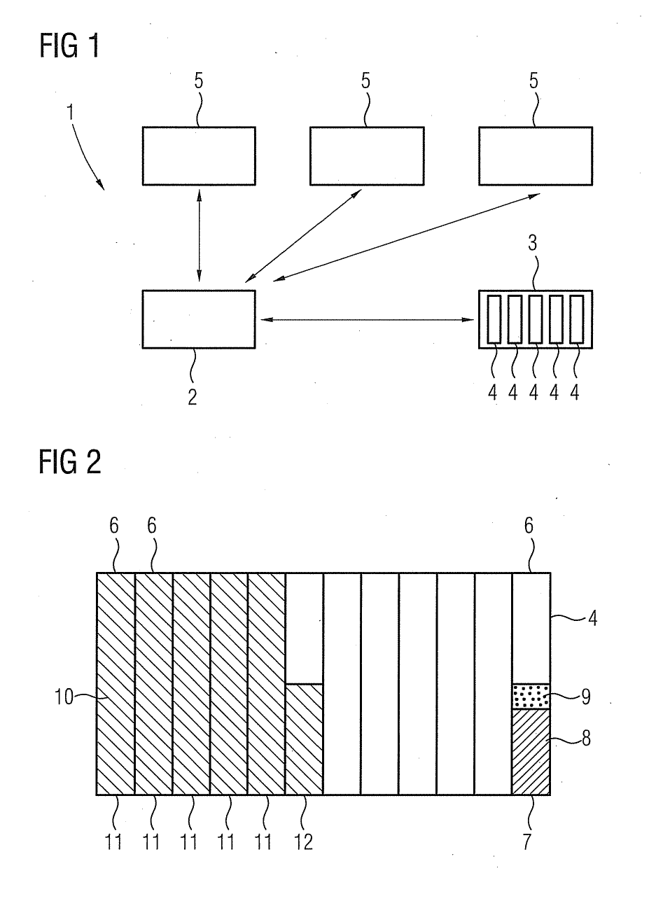

FIG. 1 shows an inventive archiving system 1. It includes a server 2 which acts as the control device, which has access to a storage device 3, in this example case a RAID, in which five hard disks 4 are provided as storage media. Each of these hard disks 4 is subdivided into physical memory areas, namely sectors, which are not shown in greater detail in FIG. 1.

Medical image data sets are to be archived in the storage device 3. These are in DICOM format and therefore comprise metadata and the actual image data. The medical image data sets may, for example, come from different imaging devices of a medical facility, for example a clinic, and are therefore usually very large if they are high-quality. The resulting archive in which new image data sets are continuously stored is consequently very large and continuously growing.

In order for the image data sets in the storage device 3 to be accessed via the server 2, workstations 5 are additionally connected to the server 2 via a network which in this case comprises a number of processors, and therefore also has provision for performing calculation and evaluation processes on the image data of the image data sets.

The data sets in the storage device 3 are therefore accessed from the workstations 5 via a user interface, so that they may be displayed, and evaluated through interconnection of the server 2.

In the archiving system 1, the server 2 is designed for executing an embodiment of the inventive method. This is explained in greater detail with FIG. 2 using the example of a single hard disk 4; the process described may be applied analogously if the storage is distributed across several hard disks 4. In this example embodiment, functions of a file system are used in order to divide the hard disk 4 into partitions 6 (logical drives). A partition 6 may be a memory area that comprises one or more sectors and is physically connected to the hard disk.

A partition 6 is used as an index memory area 7, in which a database 8 which is used for administration of the archiving system 1, and update data 9 for the metadata of the image data sets, are stored.

The remaining partitions 6, which are also physically connected memory areas, are provided for the image data sets, wherein the storage device 3 is controlled by the server 2 in such a way that the partitions 6 are filled up in chronological sequence. Occupied partition space is indicated in FIG. 2 by hatching 10. In this example, this means that the partitions 6 shown on the left, which are completely filled, may be interpreted as pure read-only areas 11, which means that no further write accesses are needed in these. Each of these read areas 11 contain chronologically sequential image data sets for a specific period.

In this embodiment of the inventive method, update processes are likewise no longer necessary in the read areas 11, since the update data 9 affecting the metadata is held in the index memory area 7. The image data sets are then only updated in their metadata if they are to be exported from the archiving system 1, for example via the network or to an external storage medium (lazy write).

This means that only two partitions 6 from the entire hard disk 4 are written and/or updated, namely area 12 which is currently being filled up and the index memory area 7. These are therefore write areas.

It should be noted at this point that, alternatively to the file system being used for the definition of partitions 6 as described here, provision may of course also be made for the physical storage location to be selected directly by a control unit of the storage device 3 or even of the hard disk 4 (disk-controller).

The advantage of an embodiment of the inventive method or of the inventive archiving system 1 is apparent in the execution of backup or transfer processes. For example, if a transfer takes place—i.e. if the data sets are to be copied to a new system—then the process described here allows at least the read areas 11 to be copied, memory area by memory area, by means of a copying program that addresses the memory areas directly. This may, for example, be a sector copying program, which copies the sector or sectors of each of the partitions 6 individually. This accelerates the copying process.

Since the read areas 11 are memory areas, access to which must still be read only, and in which no further write accesses or updates of any kind may be carried out, functions of the activation system 1 do not have to be deactivated because of the backup or transfer, at least not as long as only read areas 11 are to be copied. The transfer or backup process therefore runs optimized protocol parameters in the background for maximum performance. However, if fewer performance restrictions are required by users, a control element may be provided by means of which the priority of a backup and/or transfer process is adjustable by users.

The deactivation of functions of the archiving system 1 is therefore extremely useful if areas 7 or 12 need to be accessed.

Finally, it should also be noted that provision may be made in an embodiment of the inventive method for checking the consistency of the data in a backup or transfer on the basis of calculated checksums. This may mean that a checksum comparison is carried out for each data set copied. However, it is also possible for this to be done for each sector or for each partition, or even for all copied data. A common checksum algorithm may be used as the algorithm.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE CHARACTERS

1 Archiving system
2 Server
3 Storage device
4 Hard disk
5 Workstation
6 Partition
7 Index memory area
8 Database
9 Update data
10 Hatching
11 Read area
12 Area

What is claimed is:

1. A method for operating an archiving system for data sets using a storage device including at least one storage medium comprising physical memory areas, the method comprising:
storing the data sets in such a way to fill up the memory areas in chronological sequence.

2. The method as claimed in claim 1, wherein a physical storage location of the memory areas is selected directly by a control unit of the storage device.

3. The method as claimed in claim 1, wherein addresses in a file system are allocated to the memory areas via a function of the file system, with data being stored according to addresses selected.

4. The method as claimed in claim 1, wherein an index database, used for administration of data sets, is stored in a specially reserved index memory area.

5. The method as claimed in claim 4, wherein the data sets comprise at least one item of metadata, wherein update data for the at least one item of metadata is stored in the index memory area.

6. The method as claimed in claim 5, wherein a data set is updated on the basis of update data only when the data set is exported from the archiving system.

7. The method as claimed in claim 1, wherein when data sets are at least one of backed up and transferred, the data sets are copied memory area by memory area by a copying program that accesses the memory areas directly.

8. The method as claimed in claim 1, wherein when data sets are at least one of backed up and transferred, the operation of other administration functions of the archiving system are deactivated only for access to the memory area currently being filled up and, if necessary, to the index area.

9. The method as claimed in claim 1, wherein the priority of the at least one of backup and transfer process is adjusted by the user.

10. The method as claimed in claim 1, wherein when data sets are at least one of backed up and transferred, at least one or, where appropriate, one additional checksum, is calculated for the data sets on the basis of which it is determined, by comparison of the checksums after the copying process, whether the copying process has been successfully concluded.

11. An archiving system for data sets, comprising:
a storage device including at least one storage medium comprising physical memory areas and incorporating a control device designed for executing storing of the data sets in such a way to fill up the memory areas in chronological sequence.

12. The archiving system as claimed in claim 11, wherein the control device is a central server connected to the storage device, via which the data sets are accessible by at least one workstation.

13. The method as claimed in claim 1, wherein the method is for operating an archiving system for medical image data sets.

14. The method as claimed in claim 10, wherein the at least one or, where appropriate, one additional checksum, includes a checksum for at least one of each data set and for groups of data sets.

15. The archiving system as claimed in claim 11, wherein the method is for operating an archiving system for medical image data sets.
